(19) United States
(12) Patent Application Publication
(10) Pub. No.: US 2025/0039692 A1
(43) Pub. Date: Jan. 30, 2025

(54) DYNAMIC RECEPTION MODE SELECTION

(71) Applicant: QUALCOMM Incorporated, San Diego, CA (US)

(72) Inventors: Bo WEN, San Diego, CA (US); Vikas MAHAJAN, San Diego, CA (US); Akshay RAVI, San Diego, CA (US); Omesh Kumar HANDA, San Marcos, CA (US); Raveesh JUNEJA, Hyderabad (IN); Jie RONG, Shenzhen (CN)

(21) Appl. No.: 18/611,388

(22) Filed: Mar. 20, 2024

Related U.S. Application Data
(60) Provisional application No. 63/516,486, filed on Jul. 28, 2023.

(51) Int. Cl. H04W 24/02

(52) U.S. Cl. CPC H04W 24/02

(57) ABSTRACT

Various aspects of the present disclosure generally relate to wireless communication. In some aspects, a wireless node may receive a first set of transmissions, each transmission of the first set of transmissions corresponding to a respective interference metric of a first set of interference metrics. The wireless node may receive a second set of transmissions in association with a selected reception mode of a plurality of reception modes, wherein the selected reception mode is based on an estimated power metric and an estimated performance metric. Numerous other aspects are described.

### CROSS-REFERENCE TO RELATED APPLICATION

This Patent application claims priority to U.S. Provisional Patent Application No. 63/516,486, filed on Jul. 28, 2023, entitled “DYNAMIC RECEPTION MODE SELECTION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for dynamic reception mode selection.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a wireless node. The method may include receiving a first set of transmissions, each transmission of the first set of transmissions corresponding to a respective interference metric of a first set of interference metrics. The method may include receiving a second set of transmissions in association with a selected reception mode of a plurality of reception modes, wherein the selected reception mode is based on an estimated power metric and an estimated performance metric.

Some aspects described herein relate to a wireless node for wireless communication. The wireless node may include one or more memories and one or more processors coupled to the one or more memories. The one or more processors may be configured to cause the wireless node to receive a first set of transmissions, each transmission of the first set of transmissions corresponding to a respective interference metric of a first set of interference metrics. The one or more processors may be configured to cause the wireless node to receive a second set of transmissions in association with a selected reception mode of a plurality of reception modes, wherein the selected reception mode is based on an estimated power metric and an estimated performance metric.

Some aspects described herein relate to a non-transitory computer-readable medium that stores a set of instructions for wireless communication by a wireless node. The set of instructions, when executed by one or more processors of the wireless node, may cause the wireless node to receive a first set of transmissions, each transmission of the first set of transmissions corresponding to a respective interference metric of a first set of interference metrics. The set of instructions, when executed by one or more processors of the wireless node, may cause the wireless node to receive a second set of transmissions in association with a selected reception mode of a plurality of reception modes, wherein the selected reception mode is based on an estimated power metric and an estimated performance metric.

Some aspects described herein relate to an apparatus for wireless communication. The apparatus may include means for receiving a first set of transmissions, each transmission of the first set of transmissions corresponding to a respective interference metric of a first set of interference metrics. The apparatus may include means for receiving a second set of transmissions in association with a selected reception mode of a plurality of reception modes, wherein the selected reception mode is based on an estimated power metric and an estimated performance metric.

Aspects generally include a method, apparatus, system, computer program product, non-transitory computer-readable medium, user equipment, base station, network entity, network node, wireless node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example associated with dynamic reception modes, in accordance with the present disclosure.

FIG. 5 is a diagram illustrating an example of an optimization matrix associated with determining reception modes to be mapped to sets of transmissions, as described above.

FIG. 6 is a diagram illustrating an example of a procedure for dynamically selecting a reception mode, as described herein.

FIG. 7 is a diagram illustrating an example process performed, for example, at a wireless node or an apparatus of a wireless node, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

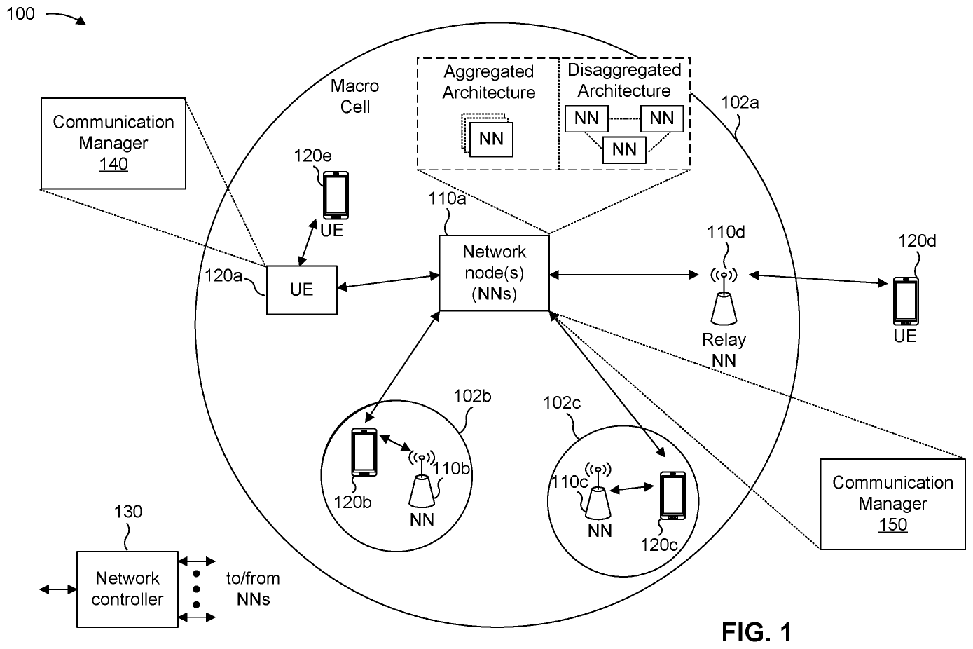

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an CNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a first set of transmissions, each transmission of the first set of transmissions corresponding to a respective interference metric of a first set of interference metrics; and receive a second set of transmissions in association with a selected reception mode of a plurality of reception modes, wherein the selected reception mode is based on an estimated power metric and an estimated performance metric. Additionally, or alternatively, the communication manager 140 may perform one or more other operations described herein.

In some aspects, the network node 110 may include a communication manager 150. As described in more detail elsewhere herein, the communication manager 150 may receive a first set of transmissions, each transmission of the first set of transmissions corresponding to a respective interference metric of a first set of interference metrics; and receive a second set of transmissions in association with a selected reception mode of a plurality of reception modes, wherein the selected reception mode is based on an estimated power metric and an estimated performance metric. Additionally, or alternatively, the communication manager 150 may perform one or more other operations described herein.

As indicated above, FIG. 1 is provided as an example. Other examples may differ from what is described with regard to FIG. 1.

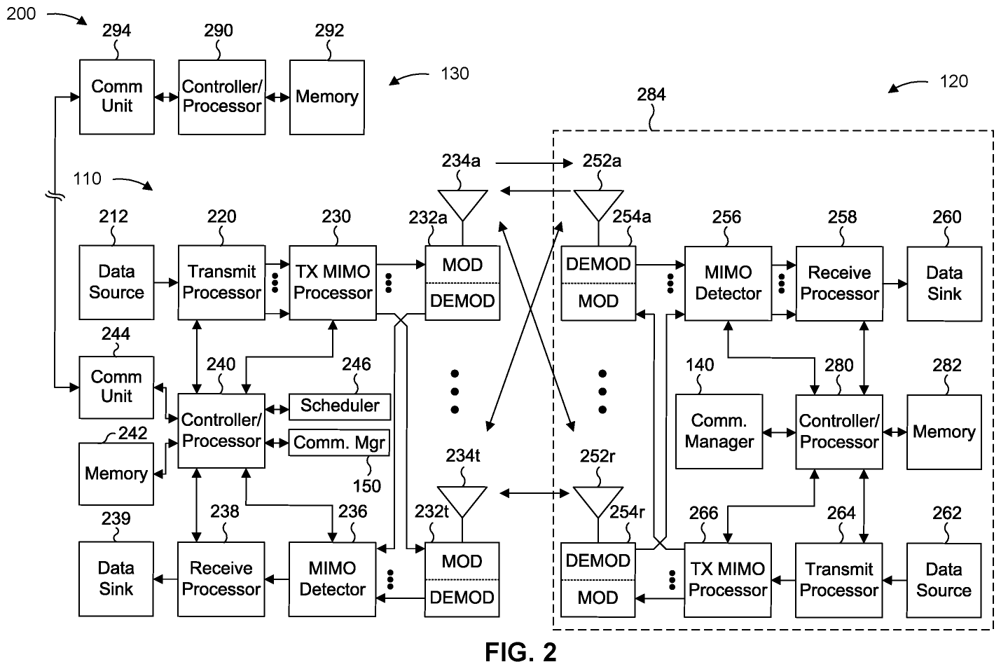

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

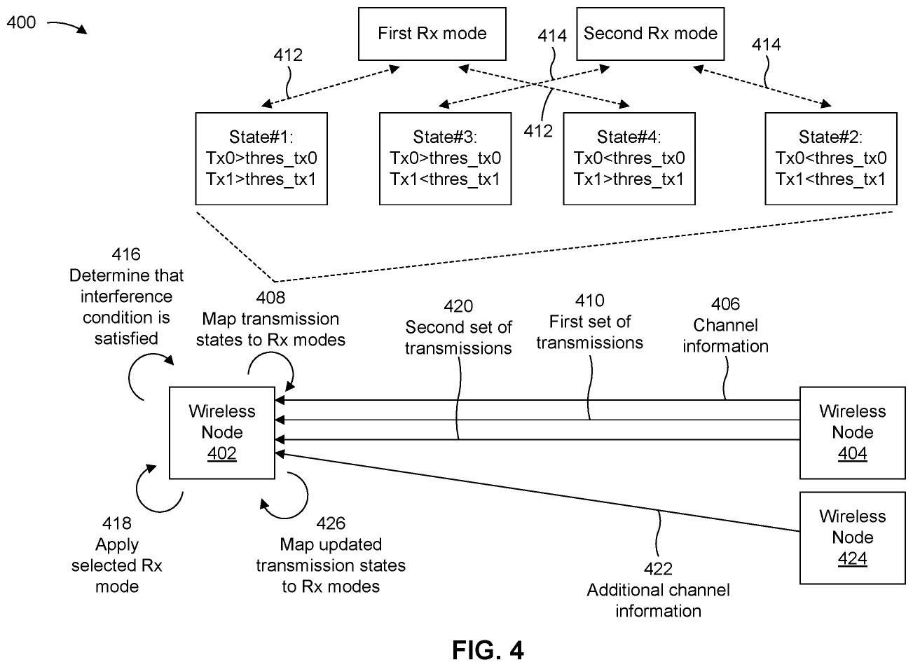

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-6).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-6).

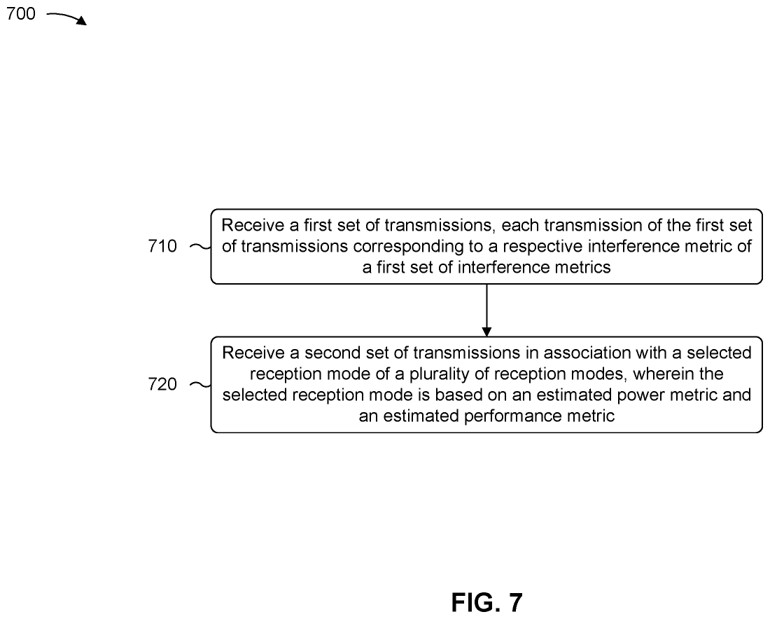

The controller/processor 240 of the network node 110, the controller/processor 280 of the UE 120, and/or any other component(s) of FIG. 2 may perform one or more techniques associated with dynamic reception modes, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7. In some examples, executing instructions may include running the instructions, converting the instructions, compiling the instructions, and/or interpreting the instructions, among other examples.

In some aspects, the UE 120 includes means for receiving a first set of transmissions, each transmission of the first set of transmissions corresponding to a respective interference metric of a first set of interference metrics; and/or means for receiving a second set of transmissions in association with a selected reception mode of a plurality of reception modes, wherein the selected reception mode is based on an estimated power metric and an estimated performance metric. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving a first set of transmissions, each transmission of the first set of transmissions corresponding to a respective interference metric of a first set of interference metrics; and/or means for receiving a second set of transmissions in association with a selected reception mode of a plurality of reception modes, wherein the selected reception mode is based on an estimated power metric and an estimated performance metric. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

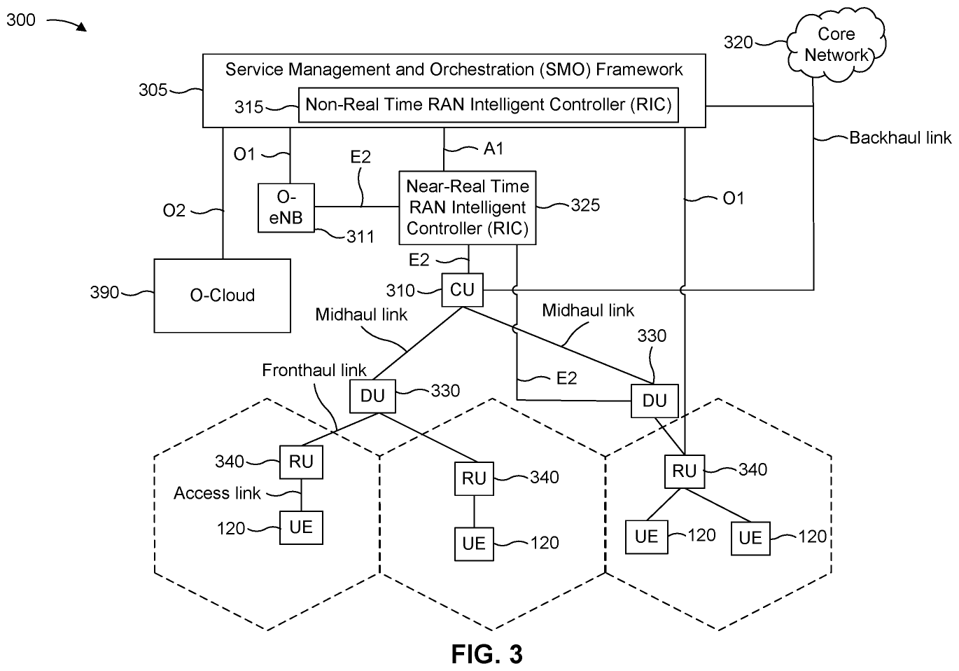

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through FI interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

In some cases, a wireless node (e.g., a UE 120 or a network node 110) may include a receiver such as, for example, a sub-6 millimeter wave (mmW) converged receiver, that may be exposed to one or more interference types due to reception of multiple transmissions. The converged receiver may be configured to process both sub-6 signals and mmW signals, and/or sub-6 signals and signals downconverted (e.g., to an intermediate frequency) from mmW. The converged receiver may be configured to use different reception modes to counter interference and improve reception signal quality. The reception modes may include, for example, a harmonic rejection mixer (HRM) mode, an internal low noise amplifier (ILNA) mode (e.g., an LNA internal to a transceiver chip having a converged receiver), a mixer first (M1) mode, a high linearity (HLIN) mode, an iLNA mode with the HRM mode enabled (ILNA_HRM), and/or an HLIN mode with the HRM mode enabled (HLIN_HRM). In some cases, some reception modes may positively impact power of reception while increasing interference and/or may decrease power while mitigating interference. For example, the HRM mode may consume significantly higher power while improving harmonic rejection, while the HLIN mode may introduce additional (e.g., about 1 decibel (dB)) desense, while improving linearity.

Some aspects described herein may include techniques to dynamically select a reception mode when interference is present (e.g., when one or more transmissions exceed a certain power level) and/or to switch to a different reception mode associated with more reception power and/or greater performance efficiency when interference is not present (e.g., when a transmission power level is low). In this way, some aspects may facilitate switching to a reception mode that optimizes and/or otherwise balances power and performance considerations based on interference conditions associated with transmissions. In this way, some aspects may provide for more efficient reception of multiple transmissions and/or may facilitate avoiding unnecessary power and/or performance impacts when interference mitigation is not needed.

FIG. 4 is a diagram illustrating an example 400 associated with dynamic reception modes, in accordance with the present disclosure. As shown in FIG. 4, a first wireless node 402 and a second wireless node 404 may communicate with one another. In some aspects, for example, the first wireless node 402 may be a UE 120 and the second wireless node 404 may be a network node 110 such as a base station, an access point, a transmission reception point (TRP), and/or a relay device, among other examples. Additionally, or alternatively, the first wireless node 402 may be a network node 110 and the second wireless node 404 may be a UE 120, the first wireless node 402 may be a first UE 120 and the second wireless node 404 may be a second UE 120, and/or the first wireless node 402 may be a first network node 110 and the second wireless node 404 may be a second network node 110, among other examples. In some aspects, the first wireless node 402 and/or the second wireless node 404 may be, may be similar to, may include, or may be included in, the UE 120 depicted in FIGS. 1-3, the network node 110 depicted in FIGS. 1 and 2, and/or one or more components of the disaggregated base station architecture 300 depicted in FIG. 3.

As shown by reference number 406, the second wireless node 404 may provide channel information to the first wireless node 402. The channel information may be provided, for example, as part of a connection procedure when the first wireless node 402 connects (e.g., via an RRC connection operation) to the second wireless node 404. The channel information may include, for example, indications of one or more channels over which the first wireless node 402 and the second wireless node 404 are to communicate, one or more bands over which the first wireless node 402 and the second wireless node 404 are to communicate, and/or transmission power levels associated with channels, bands, beams, and/or carriers.

As shown by reference number 408, the first wireless node 402 may map transmission states to reception (Rx) modes. The first wireless node 402 may use the channel information to map the transmission states to the Rx modes. In some aspects, as shown by reference number 410, the second wireless node 404 may transmit, and the first wireless node 402 may receive, a first set of transmissions. The first wireless node 402 may map the transmission states to the reception modes based on the first set of transmissions and/or the channel information.

For example, as shown, a first Rx mode may be mapped, via a first mapping 412, to a first set of transmission states (shown as “State #1” and “State #4”) and the second reception mode may be mapped, via a second mapping 414, to a second set of transmission states (shown as “State #3” and “State #2”). The first mapping 412 may be associated with a target interference level and the second mapping 414 may be associated with the target interference level. In the illustrated example, the second set of transmission states may include at least one transmission failing to satisfy an interference condition. For example, a transmission may fail to satisfy an interference condition based on an interference metric associated with the transmission being less than a threshold (shown as “thres_tx0” and/or “thres_tx1”).

As shown in the illustrated example, the first set of transmission states includes a first transmission state (“State #1”) associated with a first transmission (shown as “Tx0”) of the first set of transmissions satisfying an interference condition (“Tx0>thres_tx0”) and a second transmission (shown as “Tx1”) satisfying the interference condition (“Tx0>thres_tx1”). The first set of transmission states includes a second transmission state (“State #4”) associated with a third transmission (which may, in some cases be the first transmission, included in an estimate for a different scenario) satisfying an interference condition and a fourth transmission (which may, in some cases be the second transmission, included in an estimate for a different scenario) failing to satisfy the interference condition. Similarly, the second set of transmission states may include a third transmission state (“State #3”) associated with a fifth transmission (which may, in some cases be the first transmission, included in an estimate for a different scenario) satisfying an interference condition and a sixth transmission (which may, in some cases be the second transmission, included in an estimate for a different scenario) failing to satisfy the interference condition. The second set of transmission states also may include a fourth transmission state (“State #2”) associated with a seventh transmission (which may, in some cases be the first transmission, included in an estimate for a different scenario) failing to satisfy the interference condition and an eighth transmission (which may, in some cases be the second transmission, included in an estimate for a different scenario) failing to satisfy the interference condition. In some examples, Tx0 is representative of communications on a first antenna and Tx1 is representative of communications on a second antenna. In some such examples, the two antennas operate as MIMO or carrier aggregation antennas.

As shown by reference number 416, the first wireless node 402 may determine that an interference condition is satisfied. For example, the first wireless node 402 may determine that at least one transmission of the first set of transmissions satisfies the interference condition. In some aspects, the at least one transmission may satisfy the interference condition based on at least one interference metric of the first set of interference metrics satisfying an interference metric threshold. In some aspects, the at least one interference metric may include a transmission power level. In some aspects, the at least one transmission may satisfy the interference condition based on a time-based average of the transmission power level. In some aspects, the interference condition may be based on a type of transmission associated with the at least one transmission (e.g., a discontinuous transmission (DTX), a physical downlink control channel (PDCCH) transmission, and/or a switched uplink transmission, among other examples). In some aspects, the at least one interference metric may include a transmission interference measurement.

As shown by reference number 418, the first wireless node 402 may apply a selected reception mode of the mapped reception modes. As shown by reference number 420, the second wireless node 404 may transmit, and the first wireless node 402 may receive, a second set of transmissions. For example, in some aspects, the first wireless node 402 may receive the second set of transmissions in association with the selected reception mode. The selected reception mode may be based on an estimated power metric and an estimated performance metric.

For example, in some aspects, a first reception mode may be a high transmission (“high Tx”) reception mode and a second reception mode may be a low transmission (“low Tx”) reception mode. High transmission reception modes may be associated with transmissions having a transmission power and/or estimated interference level that satisfies a first threshold and low transmission reception modes may be associated with transmissions having a transmission power and/or estimated interference level that satisfies a second threshold (and/or that fail to satisfy the first threshold). In some aspects, the first reception mode may be selected based on a performance requirement and/or an interference mechanism.

In some aspects, the second reception mode may be determined based on a selection operation (e.g., a selection strategy). For example, in some aspects, determining the second reception mode may include determining a plurality of metric pairs, each metric pair of the plurality of metric pairs associated with a respective transmission state and a candidate reception mode of a set of candidate reception modes. For example, for each of a candidate reception mode (sometimes referred to as a configuration or “config”), the candidate reception mode (e.g., a low transmission reception mode) may be paired with the first reception mode and an estimated power metric (e.g., an average power) and an estimated performance metric (e.g., an interference and/or noise performance metric such as a desense level) may be determined. The first wireless node 402 may select a candidate reception mode of the set of candidate reception modes based on an optimization metric associated with the estimated power metric and the estimated performance metric.

As shown by reference number 422, the first wireless node 402 may receive, from a third wireless node 424 (or, in some cases, from the second wireless node 404) additional channel information. As shown by reference number 426, the first wireless node 402 may map updated transmission states to reception modes based on the additional channel information and/or an additional set of transmissions.

As indicated above, FIG. 4 is provided as an example. Other examples may differ from what is described with respect to FIG. 4.

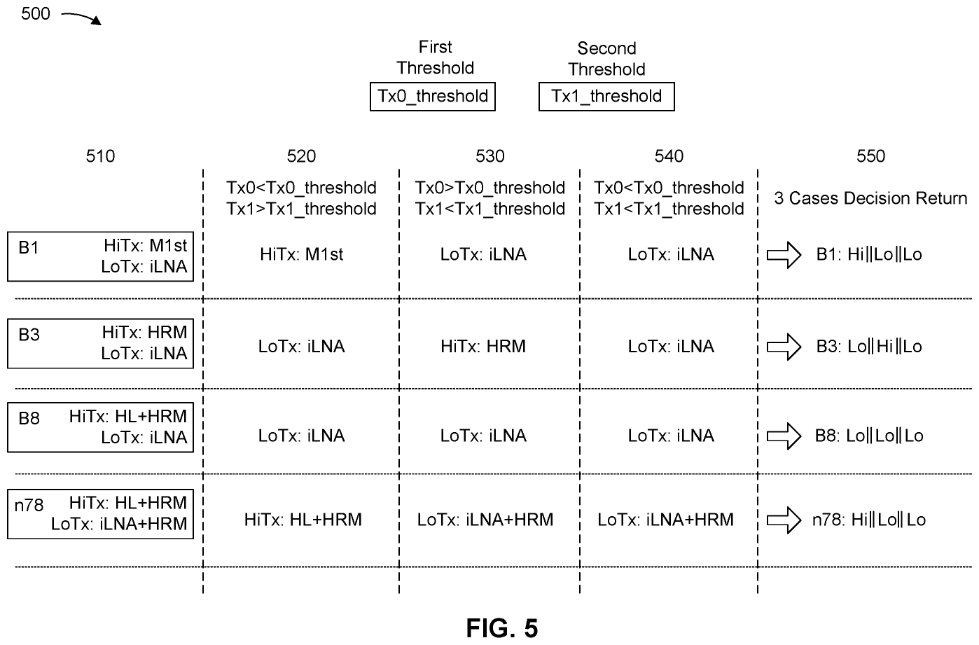

FIG. 5 is a diagram illustrating an example 500 of an optimization matrix associated with determining reception modes to be mapped to sets of transmissions, as described above. Different scenarios for a set of transmissions are represented in the different columns, and outcomes for those different scenarios are included in the final column. Each row in FIG. 5 corresponds to a frequency band (shown as “B1,” “B3,” “B8,” and “n78”). A respective set of candidate reception modes is associated with each frequency band and each cell of the matrix indicates a selected candidate reception mode (e.g., a reception mode that provides an optimization of power versus interference) of the set of candidate reception modes associated with the frequency band indicated in the corresponding row for the pair of transmissions in the corresponding column. For example, as shown, the first column includes scenarios for a pair of transmissions in which an interference metric (e.g., a transmission power) associated with a first transmission (Tx0) is less than a first threshold (Tx0_threshold) and in which an interference metric (e.g., a transmission power) associated with a second transmission (Tx1) exceeds a second threshold (Tx1_threshold). In the upper left cell, a reception mode (M1st), which is a high Tx reception mode, is indicated as the selected reception mode for the combination of the two transmissions in a frequency band denoted by “B1”. The upper right cell indicates a set of reception modes for the three different transmission combinations. The example 500 illustrates that there may be different conditions for each of a plurality of bands, which may result in different reception modes for the bands. In other examples, conditions for two or more of the bands may be similar.

For example, as shown in FIG. 5, and by reference number 510, a first column in the matrix may include a first data element to represent a high Tx reception mode and a second data element to represent a low Tx reception mode for a particular frequency band. For example, as shown in FIG. 5, the B1 frequency band may be associated with the Mist reception mode for the high Tx reception mode and the iLNA reception mode for the low Tx reception mode, the B3 frequency band may be associated with the HRM reception mode for the high Tx reception mode and the iLNA reception mode for the low Tx reception mode, the B8 frequency band may be associated with the HL+HRM reception mode for the high Tx reception mode and the iLNA reception mode for the low Tx reception mode, and the n78 frequency band may be associated with the HL+HRM reception mode for the high Tx reception mode and the iLNA+HRM reception mode for the low Tx reception mode.

As further shown in FIG. 5, and by reference number 520, a second column in the matrix indicates, for each frequency band, whether the high Tx reception mode or the low Tx reception mode is to be used when a first set of one or more conditions are satisfied (e.g., the interference metric associated with the first transmission, Tx0, is less than the first threshold, and the interference metric associated with the second transmission, Tx1, exceeds the second threshold). For example, as shown in FIG. 5, the high Tx reception mode (e.g., M1st) may be used in the B1 frequency band when the interference metric associated with the first transmission is less than the first threshold and the interference metric associated with the second transmission exceeds the second threshold. Additionally, or alternatively, the low Tx reception mode (e.g., the iLNA mode) may be used in the B3 and/or B8 frequency bands when the interference metric associated with the first transmission is less than the first threshold and the interference metric associated with the second transmission exceeds the second threshold, or the high Tx reception mode (e.g., the HL+HRM mode) may be used in the n78 frequency band when the interference metric associated with the first transmission is less than the first threshold and the interference metric associated with the second transmission exceeds the second threshold.

As further shown in FIG. 5, and by reference number 530, a third column in the matrix indicates, for each frequency band, whether the high Tx reception mode or the low Tx reception mode is to be used when a second set of one or more conditions are satisfied (e.g., when the interference metric associated with the first transmission, Tx0, exceeds the first threshold, and the interference metric associated with the second transmission, Tx1, is less than the second threshold). For example, as shown in FIG. 5, the high Tx reception mode (e.g., the HRM mode) may be used in the B3 frequency band when the interference metric associated with the first transmission exceeds the first threshold and the interference metric associated with the second transmission is less than the second threshold. Additionally, or alternatively, the low Tx reception mode (e.g., the iLNA mode or the iLNA+HRM mode) may be used in the B1, B8, and/or n78 frequency bands when the interference metric associated with the first transmission exceeds the first threshold and the interference metric associated with the second transmission is less than the second threshold.

Additionally, or alternatively, as shown by reference number 540, a fourth column in the matrix indicates, for each frequency band, whether the high Tx reception mode or the low Tx reception mode is to be used when a third set of one or more conditions are satisfied (e.g., when the interference metric associated with the first transmission, Tx0, is less than the first threshold, and the interference metric associated with the second transmission, Tx1, is less than the second threshold). For example, as shown in FIG. 5, the low Tx reception mode may be used in the B1, B3, B8, and n78 frequency bands when the interference metric associated with the first transmission is less than the first threshold and the interference metric associated with the second transmission is less than the second threshold.

Accordingly, as shown by reference number 550, a fifth column in the matrix indicates, for each frequency band, whether the high Tx reception mode or the low Tx reception mode is to be used, depending on the interference metric associated with the first transmission and/or the interference metric associated with the second transmission. For example, as shown in FIG. 5, the high Tx reception mode may be used in the B1 frequency band when the interference metric associated with the first transmission is less than the first threshold and the interference metric associated with the second transmission exceeds the second threshold, and the low Tx reception mode may otherwise be used in the B1 frequency band (e.g., when the interference metric associated with the second transmission is less than the second threshold).

Alternatively, as further shown in FIG. 5, the high Tx reception mode may be used in the B3 frequency band when the interference metric associated with the first transmission exceeds the first threshold and the interference metric associated with the second transmission is less than the second threshold, and the low Tx reception mode may otherwise be used in the B3 frequency band (e.g., when the interference metric associated with the first transmission is less than the first threshold). Furthermore, as shown and described herein, other suitable logic may be used in other frequency bands, as the interference conditions and/or other conditions impacting reception performance may vary among different frequency bands, frequency ranges, or the like.

As indicated above, FIG. 5 is provided as an example. Other examples may differ from what is described with respect to FIG. 5.

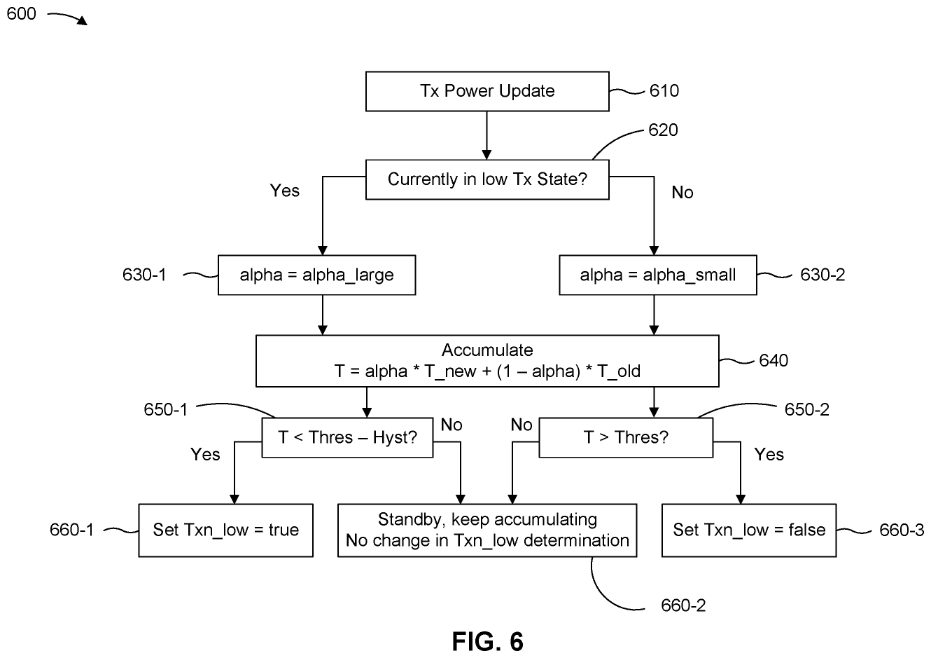

FIG. 6 is a diagram illustrating an example 600 of a procedure for dynamically selecting a reception mode, as described herein. In the example 600, selection of a reception mode may be configured as an infinite impulse response (IIR) filter or system. For example, as described herein, independent logic may be used to determine one or more parameters for selecting an appropriate reception mode for each transmission, where a large value may be chosen for an alpha parameter when the current state is a reception state when transmissions are associated with low interference metrics and a relatively small value may be chosen for the alpha parameter when then the current state is a reception state when transmissions are associated with high interference metrics. The large value of the alpha parameter may be one or more orders of magnitude higher than the small value of the alpha parameter in some examples.

For example, as shown by block 610, a Tx power update may be triggered based on one or more conditions being satisfied. For example, in some aspects, the Tx power update may be triggered based on a change to a Tx level (e.g., a DTx value) satisfying a threshold, such as −50 dBm or another suitable value. Additionally, or alternatively, the Tx power update may be triggered based on other suitable conditions. In some aspects, as further shown by block 620, a wireless node performing the dynamic reception mode selection may then determine whether a current Tx state is a low Tx state (e.g., associated with low interference metrics) or a high Tx state (e.g., associated with high interference metrics). As shown by reference number 630-1, in cases where the wireless node determines that the current Tx state is a low Tx state, the wireless node may set the alpha parameter to a high value (e.g., a value that places more weight on more recent Tx measurements, such as a value that is closer to one than to zero). Alternatively, as shown by reference number 630-2, in cases where the wireless node determines that the current Tx state is a high Tx state, the wireless node may set the alpha parameter to a low value (e.g., a value that places more weight on older recent Tx measurements, such as a value that is closer to zero than to one).

As further shown in FIG. 6, at block 640, the wireless node may then determine an accumulated value for a Tx parameter (e.g., a Tx interference metric), which may be calculated based on the value of the alpha parameter that is determined based on the current Tx state. For example, as shown in FIG. 6, the accumulated value for the Tx parameter may be determined based on the following expression:

$$T = α \times {T}_{new} + ( 1 - α ) {T}_{old} ,$$

where α is the value of the alpha parameter that is determined based on the current Tx state, T_{new} is the current (accumulated) value of the interference metric used to determine the target reception state, and T_{old} is the previous (accumulated) value of the interference metric used to determine the target reception state. As further shown in FIG. 6, at block 650-1, the wireless node may determine whether the current accumulated value of the Tx parameter, T, is less than a threshold minus a hysteresis, where the hysteresis may have a value that is determined to avoid damage to hardware of the wireless node and/or to avoid frequent changes to the Rx mode used at the wireless node. Additionally, or alternatively, as shown by block 650-2, the wireless node may determine whether the current accumulated value of the Tx parameter, T, exceeds a threshold. As shown in FIG. 6, and by block 660-1, the wireless node may select a low Tx mode as a current reception mode when the current (accumulated) value of the interference metric used to determine the target reception state is less than the threshold minus the hysteresis. Alternatively, as shown by block 660-2, the wireless node may select a current Tx mode (e.g., remain in standby, and continue to accumulate Tx interference metrics without changing the current Rx mode) when the current (accumulated) value of the interference metric used to determine the target reception state is equal to or exceeds the threshold minus the hysteresis, or is less than the threshold. Alternatively, as shown by block 660-3, the wireless node may select a high Tx mode when the current (accumulated) value of the interference metric used to determine the target reception state exceeds the threshold.

As indicated above, FIG. 6 is provided as an example. Other examples may differ from what is described with respect to FIG. 6.

FIG. 7 is a diagram illustrating an example process 700 performed, for example, at a wireless node or an apparatus of a wireless node, in accordance with the present disclosure. Example process 700 is an example where the apparatus or the wireless node (e.g., UE 120 and/or network node 110) performs operations associated with dynamic reception mode selection.

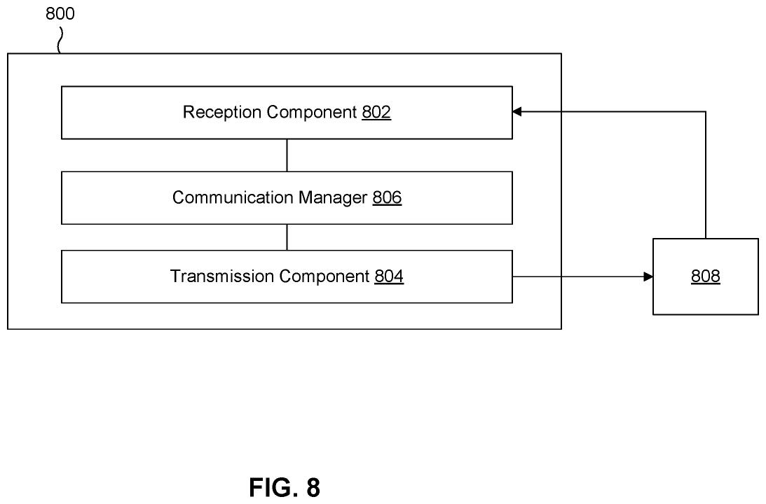

As shown in FIG. 7, in some aspects, process 700 may include receiving a first set of transmissions, each transmission of the first set of transmissions corresponding to a respective interference metric of a first set of interference metrics (block 710). For example, the wireless node (e.g., using reception component 802 and/or communication manager 806, depicted in FIG. 8) may receive a first set of transmissions, each transmission of the first set of transmissions corresponding to a respective interference metric of a first set of interference metrics, as described above.

As further shown in FIG. 7, in some aspects, process 700 may include receiving a second set of transmissions in association with a selected reception mode of a plurality of reception modes, wherein the selected reception mode is based on an estimated power metric and an estimated performance metric (block 720). For example, the wireless node (e.g., using reception component 802 and/or communication manager 806, depicted in FIG. 8) may receive a second set of transmissions in association with a selected reception mode of a plurality of reception modes, wherein the selected reception mode is based on an estimated power metric and an estimated performance metric, as described above.

Process 700 may include additional aspects, such as any single aspect or any combination of aspects described below and/or in connection with one or more other processes described elsewhere herein.

In a first aspect, receiving the second set of transmissions in association with the selected reception mode comprises receiving the second set of transmissions in association with the selected reception mode based on at least one transmission of the first set of transmissions satisfying an interference condition.

In a second aspect, alone or in combination with the first aspect, the at least one transmission satisfies the interference condition based on at least one interference metric of the first set of interference metrics satisfying an interference metric threshold.

In a third aspect, alone or in combination with one or more of the first and second aspects, the at least one interference metric comprises a transmission power level.

In a fourth aspect, alone or in combination with one or more of the first through third aspects, the at least one transmission satisfies the interference condition based on a time-based average of the transmission power level.

In a fifth aspect, alone or in combination with one or more of the first through fourth aspects, the interference condition is based on a type of transmission associated with the at least one transmission.

In a sixth aspect, alone or in combination with one or more of the first through fifth aspects, the at least one interference metric comprises a transmission interference measurement.

In a seventh aspect, alone or in combination with one or more of the first through sixth aspects, the plurality of reception modes comprises a first reception mode and a second reception mode.

In an eighth aspect, alone or in combination with one or more of the first through seventh aspects, the first reception mode is mapped, via a first mapping, to a first set of transmission states and the second reception mode is mapped, via a second mapping, to a second set of transmission states.

In a ninth aspect, alone or in combination with one or more of the first through eighth aspects, the first mapping is associated with a target interference level and the second mapping is associated with the target interference level.

In a tenth aspect, alone or in combination with one or more of the first through ninth aspects, the second set of transmission states comprises at least one transmission of the first set of transmissions failing to satisfy an interference condition.

In an eleventh aspect, alone or in combination with one or more of the first through tenth aspects, the first set of transmission states comprises a first transmission state including a first transmission of the first set of transmissions satisfying an interference condition and a second transmission of the first set of transmissions satisfying the interference condition, and a second transmission state including a third transmission of the first set of transmissions satisfying an interference condition and a fourth transmission of the first set of transmissions failing to satisfy the interference condition.

In a twelfth aspect, alone or in combination with one or more of the first through eleventh aspects, the second set of transmission states comprises a third transmission state including a fifth transmission of the first set of transmissions satisfying an interference condition and a sixth transmission of the first set of transmissions failing to satisfy the interference condition, and a fourth transmission state including a seventh transmission of the first set of transmissions failing to satisfy the interference condition and an eighth transmission of the first set of transmissions failing to satisfy the interference condition.

In a thirteenth aspect, alone or in combination with one or more of the first through twelfth aspects, process 700 includes determining the second reception mode based on the estimated power metric and the estimated performance metric.

In a fourteenth aspect, alone or in combination with one or more of the first through thirteenth aspects, determining the second reception mode comprises determining a plurality of metric pairs, each metric pair of the plurality of metric pairs associated with a respective transmission state and a candidate reception mode of a set of candidate reception modes, and selecting a candidate reception mode of the set of candidate reception modes based on an optimization metric associated with the estimated power metric and the estimated performance metric.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a wireless node, or a wireless node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 and/or 150 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 4-6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE 120 and/or the network node 110 described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, one or more modems, one or more demodulators, one or more MIMO detectors, one or more receive processors, one or more controllers/processors, one or more memories, or a combination thereof, of the UE 120 and/or the network node 110 described in connection with FIG. 2. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, one or more modems, one or more modulators, one or more transmit MIMO processors, one or more transmit processors, one or more controllers/processors, one or more memories, or a combination thereof, of the UE 120 and/or the network node 110 described in connection with FIG. 2. In some aspects, the transmission component 804 may be co-located with the reception component 802 in one or more transceivers.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive a first set of transmissions, each transmission of the first set of transmissions corresponding to a respective interference metric of a first set of interference metrics. The reception component 802 may receive a second set of transmissions in association with a selected reception mode of a plurality of reception modes, wherein the selected reception mode is based on an estimated power metric and an estimated performance metric.

The communication manager 806 may determine the second reception mode based on the estimated power metric and the estimated performance metric.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a wireless node, comprising: receiving a first set of transmissions, each transmission of the first set of transmissions corresponding to a respective interference metric of a first set of interference metrics; and receiving a second set of transmissions in association with a selected reception mode of a plurality of reception modes, wherein the selected reception mode is based on an estimated power metric and an estimated performance metric.

Aspect 2: The method of Aspect 1, wherein receiving the second set of transmissions in association with the selected reception mode comprises receiving the second set of transmissions in association with the selected reception mode based on at least one transmission of the first set of transmissions satisfying an interference condition.

Aspect 3: The method of Aspect 2, wherein the at least one transmission satisfies the interference condition based on at least one interference metric of the first set of interference metrics satisfying an interference metric threshold.

Aspect 4: The method of Aspect 3, wherein the at least one interference metric comprises a transmission power level.

Aspect 5: The method of Aspect 4, wherein the at least one transmission satisfies the interference condition based on a time-based average of the transmission power level.

Aspect 6: The method of any of Aspects 3-5, wherein the interference condition is based on a type of transmission associated with the at least one transmission.

Aspect 7: The method of any of Aspects 3-6, wherein the at least one interference metric comprises a transmission interference measurement.

Aspect 8: The method of any of Aspects 1-7, wherein the plurality of reception modes comprises a first reception mode and a second reception mode.

Aspect 9: The method of Aspect 8, wherein the first reception mode is mapped, via a first mapping, to a first set of transmission states and the second reception mode is mapped, via a second mapping, to a second set of transmission states.

Aspect 10: The method of Aspect 9, wherein the first mapping is associated with a target interference level and the second mapping is associated with the target interference level.

Aspect 11: The method of either of Aspects 9 or 10, wherein the second set of transmission states comprises at least one transmission of the first set of transmissions failing to satisfy an interference condition.

Aspect 12: The method of any of Aspects 9-11, wherein the first set of transmission states comprises: a first transmission state including a first transmission of the first set of transmissions satisfying an interference condition and a second transmission of the first set of transmissions satisfying the interference condition; and a second transmission state including a third transmission of the first set of transmissions satisfying an interference condition and a fourth transmission of the first set of transmissions failing to satisfy the interference condition.

Aspect 13: The method of Aspect 12, wherein the second set of transmission states comprises: a third transmission state including a fifth transmission of the first set of transmissions satisfying an interference condition and a sixth transmission of the first set of transmissions failing to satisfy the interference condition; and a fourth transmission state including a seventh transmission of the first set of transmissions failing to satisfy the interference condition and an eighth transmission of the first set of transmissions failing to satisfy the interference condition.

Aspect 14: The method of any of Aspects 8-13, further comprising determining the second reception mode based on the estimated power metric and the estimated performance metric.

Aspect 15: The method of Aspect 14, wherein determining the second reception mode comprises: determining a plurality of metric pairs, each metric pair of the plurality of metric pairs associated with a respective transmission state and a candidate reception mode of a set of candidate reception modes; and selecting a candidate reception mode of the set of candidate reception modes based on an optimization metric associated with the estimated power metric and the estimated performance metric.

Aspect 16: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-15.

Aspect 17: An apparatus for wireless communication at a device, the apparatus comprising one or more memories and one or more processors coupled to the one or more memories, the one or more processors configured to cause the device to perform the method of one or more of Aspects 1-15.

Aspect 18: An apparatus for wireless communication, the apparatus comprising at least one means for performing the method of one or more of Aspects 1-15.

Aspect 19: A non-transitory computer-readable medium storing code for wireless communication, the code comprising instructions executable by one or more processors to perform the method of one or more of Aspects 1-15.

Aspect 20: A non-transitory computer-readable medium storing a set of instructions for wireless communication, the set of instructions comprising one or more instructions that, when executed by one or more processors of a device, cause the device to perform the method of one or more of Aspects 1-15.

Aspect 21: A device for wireless communication, the device comprising a processing system that includes one or more processors and one or more memories coupled with the one or more processors, the processing system configured to cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of”′ a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a wireless node, comprising:
receiving a first set of transmissions, each transmission of the first set of transmissions corresponding to a respective interference metric of a first set of interference metrics; and
receiving a second set of transmissions in association with a selected reception mode of a plurality of reception modes, wherein the selected reception mode is based on an estimated power metric and an estimated performance metric.

2. The method of claim 1, wherein receiving the second set of transmissions in association with the selected reception mode comprises receiving the second set of transmissions in association with the selected reception mode based on at least one transmission of the first set of transmissions satisfying an interference condition.

3. The method of claim 2, wherein the at least one transmission satisfies the interference condition based on at least one interference metric of the first set of interference metrics satisfying an interference metric threshold.

4. The method of claim 3, wherein the at least one interference metric comprises a transmission power level.

5. The method of claim 4, wherein the at least one transmission satisfies the interference condition based on a time-based average of the transmission power level.

6. The method of claim 3, wherein the interference condition is based on a type of transmission associated with the at least one transmission.

7. The method of claim 3, wherein the at least one interference metric comprises a transmission interference measurement.

8. The method of claim 1, wherein the plurality of reception modes comprises a first reception mode that is mapped, via a first mapping, to a first set of transmission states and a second reception mode that is mapped, via a second mapping, to a second set of transmission states.

9. The method of claim 8, wherein the first mapping is associated with a target interference level and the second mapping is associated with the target interference level.

10. The method of claim 8, wherein the second set of transmission states comprises at least one transmission of the first set of transmissions failing to satisfy an interference condition.

11. The method of claim 8, wherein the first set of transmission states comprises:
a first transmission state including a first transmission of the first set of transmissions satisfying an interference condition and a second transmission of the first set of transmissions satisfying the interference condition; and
a second transmission state including a third transmission of the first set of transmissions satisfying an interference condition and a fourth transmission of the first set of transmissions failing to satisfy the interference condition.

12. The method of claim 11, wherein the second set of transmission states comprises:
a third transmission state including a fifth transmission of the first set of transmissions satisfying an interference condition and a sixth transmission of the first set of transmissions failing to satisfy the interference condition; and
a fourth transmission state including a seventh transmission of the first set of transmissions failing to satisfy the interference condition and an eighth transmission of the first set of transmissions failing to satisfy the interference condition.

13. The method of claim 8, further comprising determining the second reception mode based on the estimated power metric and the estimated performance metric.

14. The method of claim 13, wherein determining the second reception mode comprises:
determining a plurality of metric pairs, each metric pair of the plurality of metric pairs associated with a respective transmission state and a candidate reception mode of a set of candidate reception modes; and
selecting a candidate reception mode of the set of candidate reception modes based on an optimization metric associated with the estimated power metric and the estimated performance metric.

15. A wireless node for wireless communication, comprising:
one or more memories; and
one or more processors coupled to the one or more memories and configured to cause the wireless node to:
receive a first set of transmissions, each transmission of the first set of transmissions corresponding to a respective interference metric of a first set of interference metrics; and
receive a second set of transmissions in association with a selected reception mode of a plurality of reception modes, wherein the selected reception mode is based on an estimated power metric and an estimated performance metric.

16. The wireless node of claim 15, wherein the one or more processors, to cause the wireless node to receive the second set of transmissions in association with the selected reception mode, are configured to cause the wireless node to receive the second set of transmissions in association with the selected reception mode based on at least one transmission of the first set of transmissions satisfying an interference condition.

17. The wireless node of claim 16, wherein the at least one transmission satisfies the interference condition based on at least one interference metric of the first set of interference metrics satisfying an interference metric threshold.

18. The wireless node of claim 17, wherein the at least one interference metric comprises one or more of a transmission power level or a transmission interference measurement, and wherein the interference condition is based on a type of transmission associated with the at least one transmission.

19. The wireless node of claim 15, wherein the plurality of reception modes include a first reception mode that is mapped, via a first mapping, to a first set of transmission states and a second reception mode that is mapped, via a second mapping, to a second set of transmission states.

20. An apparatus for wireless communication, comprising:
means for receiving a first set of transmissions, each transmission of the first set of transmissions corresponding to a respective interference metric of a first set of interference metrics; and
means for receiving a second set of transmissions in association with a selected reception mode of a plurality of reception modes, wherein the selected reception mode is based on an estimated power metric and an estimated performance metric.
